(19) United States
(12) Patent Application Publication
(10) Pub. No.: US 2009/0066709 A1
(43) Pub. Date: Mar. 12, 2009

(54) DISPLAY DRIVER

(75) Inventor: Hironori Minamizaki, Kanagawa-ken (JP)

Correspondence Address: Gregory Turocy;Amin, Turocy & Calvin, LLP, 24TH Floor, 1900 East 9th Street, Cleveland, OH, 44114, US

(73) Assignee: KABUSHIKI KAISHA TOSHIBA, Tokyo (JP)

(21) Appl. No.: 12/186,952

(22) Filed: Aug. 6, 2008

(30) Foreign Application Priority Data
Aug. 10, 2007 (JP) 2007-209848

(51) Int. Cl. G06F 12/06

(52) U.S. Cl. 345/572

(57) ABSTRACT

A display driver for sending display data to a display panel includes a sampling circuit and a selector. The sampling circuit receives moving image data and a sampling signal generated by a write signal and an address designated with an address decoder and captures the moving image data on the basis of the sampling signal. The selector receives still image data, a selecting signal and the moving image data captured by the sampling circuit and selects one of the still image data and the moving image data on the basis of the selecting signal.

### CROSS REFERENCE TO RELATED APPLICATION

This application is based upon and claims the benefit of priority from the prior Japanese Patent Application No. P2007-209848, filed on Aug. 10, 2007, the entire contents of which are incorporated herein by reference.

### FIELD OF THE INVENTION

The present invention relates to a display driver used for a display device.

### BACKGROUND OF THE INVENTION

Image data, including still images and moving images, to be displayed on a liquid crystal display device has been recently increasing in amount. Still image data has small amount of processing load, and is generated by a CPU (Central Processing Unit) that integratedly controls a whole liquid crystal display device. Still image data thus generated is transferred to a graphic memory (RAM), frame-synchronized, and retrieved per data unit, for instance per one scanning line. On the other hand, moving image data requires large amount of processing and is required to be processed in real time. Therefore, moving image data is generated by a special controller dedicated to moving image data, such as a DSP (Digital Signal Processor), which is provided separately from a CPU for performing processings including sending and receiving still image data and the like. Japanese Patent Application Publication No. 2002-323881 discloses a data line driver that displays and drives display data.

In the data line driver, a circuit for processing still image data and a bus for transmitting the still image data are provided separately from a circuit for processing moving image data and a bus for transmitting the moving image data. It causes a problem of increasing the circuit size of the data line driver. In addition, in the data line driver, the numbers of signals and data buses are also increased. It brings about a problem that the chip size of the data line driver is increased.

### SUMMARY OF THE INVENTION

According to an aspect of the invention is provided a display driver for sending display data to a display panel, comprising a sampling circuit to receive moving image data and a sampling signal generated by a write signal and an address designated with an address decoder, the sampling circuit capturing the moving image data on the basis of the sampling signal and a selector to receive still image data, a selecting signal and the moving image data captured by the sampling circuit, the selector selecting one of the still image data and the moving image data on the basis of the selecting signal.

According to another aspect of the invention is provided a display driver for sending display data to a display panel, comprising an address generator to receive a startup signal and a clock signal, the address generator starting operation with the startup signal, to generate an address synchronized with the clock signal, a column address decoder to receive a column address outputted from the address generator, a raw address decoder to receive a raw address outputted from the address generator, a write circuit to capture still image data and the column address outputted from the column address decoder on the basis of a write signal, a graphic memory to write the still image data to an address of the graphic memory designated with the column address decoder and the raw address decoder by operation of the write circuit, based on an address generated with the address generator, a sampling circuit to receive moving image data and a sampling signal generated by the write signal and a column address designated with the column address decoder, the sampling circuit capturing the moving image data on the basis of the sampling signal, a selector to receive still image data written on the graphic memory, a selecting signal and the moving image data captured by the sampling circuit, the selector selecting one of the still image data and the moving image data on the basis of the selecting signal and a line memory to receive a latch signal and display data outputted from the selector, the line memory latching one of the scanning lines of the display data, on the basis of the latch signal.

According to another aspect of the invention is provided a display driver for sending display data to a display panel, comprising an address generator to receive a startup signal and a clock signal, the address generator starting operation with the startup signal, the address generator to generate an address synchronized with the clock signal, a column address decoder to receive a column address outputted from the address generator, a raw address decoder to receive a raw address outputted from the address generator, a write circuit to capture still image data and the column address outputted from the column address decoder on the basis of a write signal, a graphic memory to write the still image data to an address of the graphic memory designated with the column address decoder and the raw address decoder by operating of the write circuit, based on an address generated with the address generator, a sampling circuit to receive moving image data and a sampling signal generated by the write signal and a column address designated with the column address decoder, the sampling circuit capturing the moving image data on the basis of the sampling signal, a first selector to receive still image data written on the graphic memory, a selecting signal and the moving image data captured by the sampling circuit, the first selector selecting one of the still image data and the moving image data on the basis of the selecting signal, a line memory to receive a latch signal and display data outputted from the selector, the line memory latching one of the scanning lines of the display data, on the basis of the latch signal and a second selector to receive a color data selecting signal and the one of the scanning lines of the display data outputted from the line memory, the second selector timesharing the one of the scanning lines of the display data by n times for red data, green data and blue data respectively, on the basis of the color data selecting signal, wherein n is a positive integer, and a value of n is equal to three or multiples of three.

### BRIEF DESCRIPTION OF THE DRAWINGS

FIG. 1 is a schematic block diagram indicating a liquid crystal display device according to a first embodiment of the present invention.

FIG. 2 is a block diagram indicating a data line driver as a display driver according to the first embodiment of the present invention.

FIG. 3 is a block diagram indicating a data line driver as a conventional display driver.

FIG. 4 is a schematic diagram indicating a flow of image data processings in the data line driver of this embodiment according to the first embodiment of the present invention.

FIG. 5 is a schematic diagram indicating a flow of image data processings in a conventional data line driver.

FIG. 6 is a diagram indicating the effect of sharing according to the first embodiment of the present invention.

FIG. 7 is a block diagram indicating a data line driver as a display driver according to a second embodiment of the present invention.

FIG. 8 is a block diagram indicating a data line driver as a display driver according to a third embodiment of the present invention.

FIG. 9 is a block diagram indicating a data line driver as a display driver according to a forth embodiment of the present invention.

FIG. 10 is a block diagram indicating a data line driver as a display driver according to a fifth embodiment of the present invention.

### DETAILED DESCRIPTION OF THE INVENTION

Embodiments of the present invention will be described with reference to the accompanying drawings.

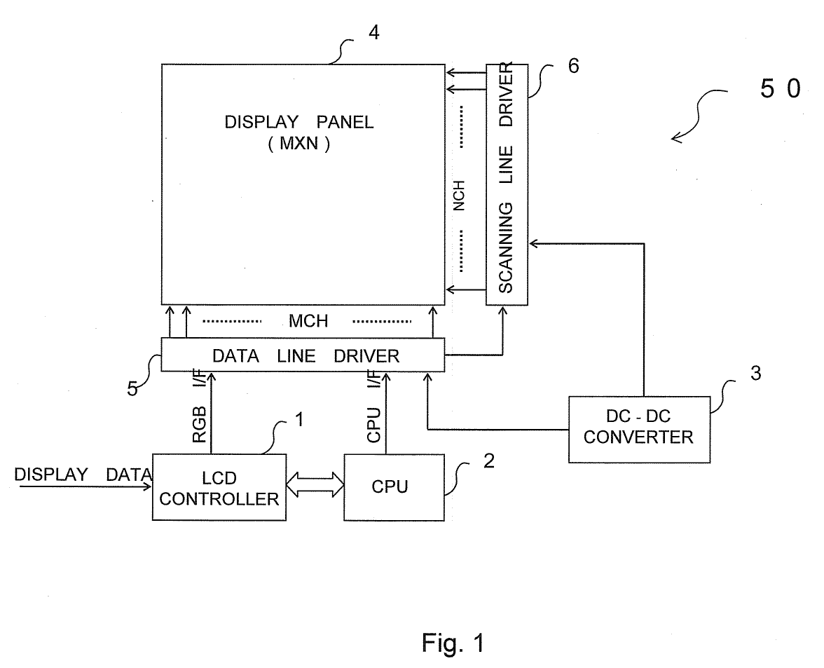

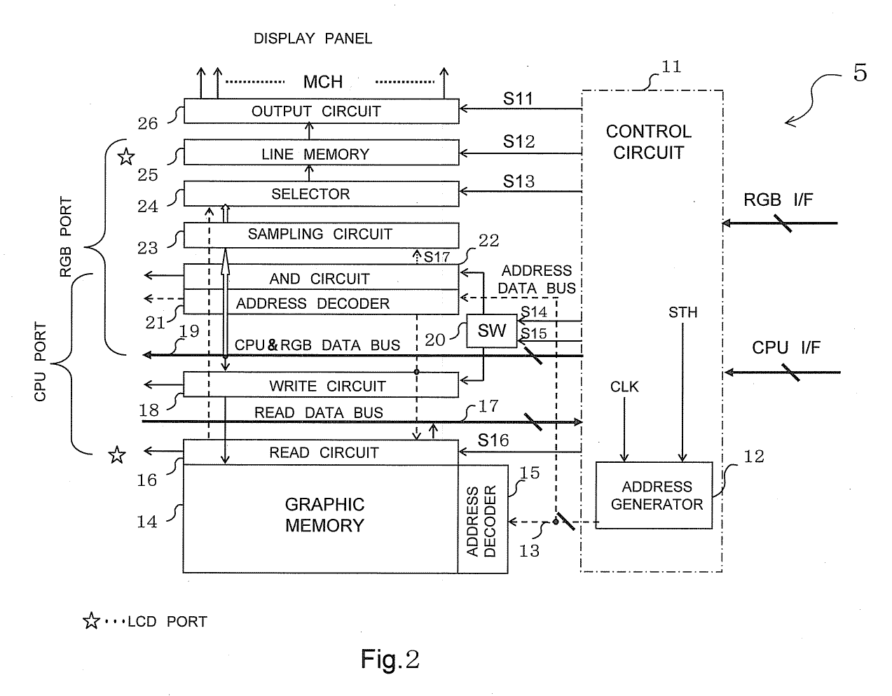

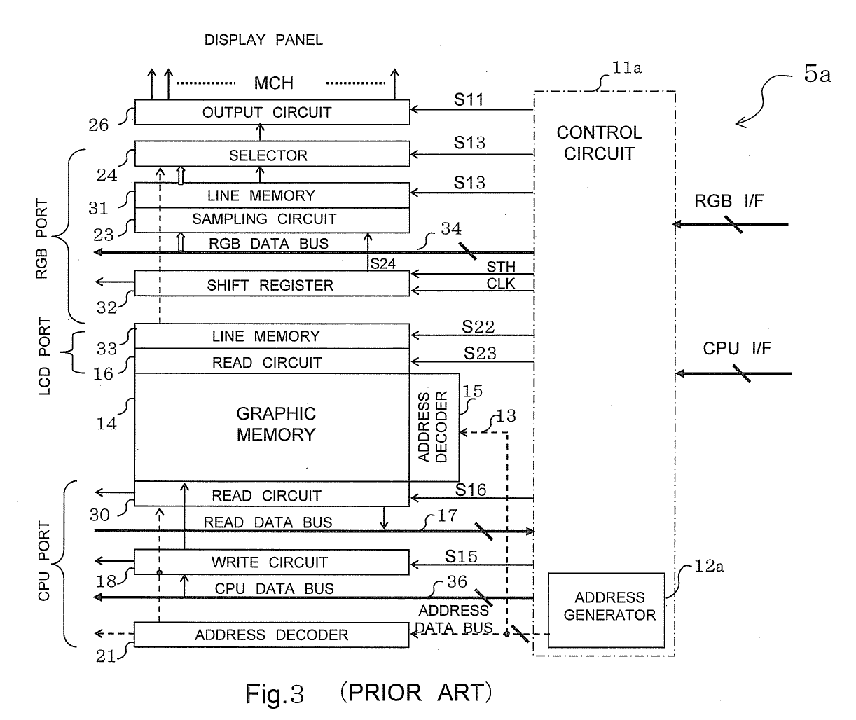

A display driver according to the first embodiment of the present invention will be described referring to drawings. FIG. 1 is a schematic block diagram indicating a liquid crystal display device; FIG. 2 is a block diagram indicating a data line driver as a display driver; FIG. 3 is a block diagram indicating a data line driver as a conventional display driver. In this embodiment, a circuit is shared to be used for the processings for the moving image data and that for the still image data, and a data bus is also shared.

As shown in FIG. 1, a liquid crystal display device 50 is provided with an LCD controller 1, a CPU 2, a DC-DC converter 3, a display panel 4, a data line driver 5, and a scanning line driver 6. The liquid crystal display device 50 is used, for example, as a display device for a QVGA portable terminal. Here, the data line driver 5 is also called an X driver, a source driver, or a display driver. The scanning line driver 6 is also called a Y driver or a gate driver. In addition, a processor such as a DSP (Digital Signal Processor) is used for the LCD controller 1. A media processor in which the LCD controller 1 and the CPU 2 are integrated, or the like may be used.

The LCD controller 1 receives RGB display data, and outputs moving image data and control signals to the data line driver 5 through an RGB I/F (interface).

The CPU (Central Processing Unit) 2 controls integratedly the whole of the liquid crystal display device 50 (e.g., controls LCD controller 1 and DC-DC converter 3, and the like) and outputs still image data and control signals to the data line driver 5. In addition, the CPU receives data and signals sent back from the data line driver 5.

The DC-DC converter 3 receives an external power supply and generates, for example, a boosted power supply necessary for the operation of the data line driver 5 and the scanning line driver 6 and then supplies it to the data line driver 5 and the scanning line driver 6.

The data line driver 5 receives moving image data and control signals outputted from the LCD controller 1, still image data and control signals outputted from the CPU 2 and a power supply supplied from the DC-DC controller 3. The data line driver 5 outputs display data (for instance, 240 CH of display data) necessary for the display drive of the display panel 4 to the display panel 4. The data line driver 5 also outputs control signals synchronized with display data to the scanning line driver 6.

The scanning line driver 6 receives control signals outputted from the data line driver 5 and a power supply supplied from the DC-DC controller 3. The scanning line driver 6 outputs control voltage information necessary for the display drive of the display panel 4 (e.g., 320 CH of pieces of control voltage information) to the gate of the TFT (Thin Film Transistor) of the display panel 4.

The display panel 4 provides with unillustrated TFTs, retention capacitances, pixel electrodes (liquid crystal cells) and scanning line loads. The display panel 4 receives display data including still image data and moving image data outputted from the data line driver 5 and the control voltage of the TFT outputted from the scanning lines driver 6. The display panel 4 can display simultaneously a still image display-driven on the basis of still image data and a moving image display-driven on the basis of moving image data.

As shown in FIG. 2, the data line driver 5 is provided with a control circuit 11, a graphic memory (RAM) 14, an address decoder 15, a read circuit 16, a write circuit 18, a switch 20, an address decoder 21, an AND circuit 22, a sampling circuit 23, a selector 24, a line memory 25, an output circuit 26, an address data bus 13, a read data bus 17 and a CPU & RGB data bus 19.

The data line driver 5 receives unillustrated moving image data (RGB data), a clock signal, a horizontal synchronizing signal, and a vertical synchronizing signal outputted from the LCD controller 1 through the RGB I/F (interface). The data line driver 5 also receives unillustrated still image data (CPU data), a write signal, a read signal, and other control signals outputted from the CPU 2 through a CPU I/F (interface).

Here, the read circuit 16, the read data bus 17, the right circuit 18, the CPU & RGB data bus 19, the switch 20, the address decoder 21, and the AND circuit 22 are included in a CPU port. The CPU & RGB data bus 19, the switch 20, the address decoder 21, the AND circuit 22, the sampling circuit 23, the selector 24, and the line memory 25 are included in an RGB port. The read circuit 16 and the line memory 25 are included in an LCD port.

A shared portion of the CPU port and the RGB port includes the CPU & RGB data bus 19, the switch 20, the address decoder 21 and the AND circuit 22. A shared portion of the CPU port and the LCD port includes the read circuit 16. A shared portion of the RGB port and the LCD port includes the line memory 25.

The address generator 12 is provided in the control circuit 11. The address generator 12 outputs address data necessary for writing still image data in the graphic memory (RAM) 14 to the address data bus 13. The address generator 12 receives a startup signal STH and a clock signal CLK and is used as a counter. The address generator 12 is activated with the startup signal STH, and generates a column address synchronized with the clock signal CLK. This column address is assigned to moving image data.

The address data is inputted, via the address data bus 13, in the address decoder 15 as a row address decoder and in the address decoder 21 as a column address decoder. Here, the number of address buses 13 to be connected to the address decoder 15 is 9 for instance, and the number of address buses 13 to be connected to the address decoder 21 is 8 for instance.

The address decoder 21 specifies the column address of still image data to be written into the graphic memory (RAM) 14, and specifies a column address necessary for capturing moving image data in the sampling circuit 23. In other words, the address decoder 21 corresponds with both still image data and moving image data.

The read data bus 17 is composed of 24 of read data buses for example, and outputs display data written into the graphic memory (RAM) 14 outputted via the read circuit 16 to the control circuit 11. The read circuit 16 receives a read signal S16 and is operated on the basis of the read signal S16.

The switch 20 (selecting circuit) receives a selecting signal S14 and a write signal S15, and selectively outputs, depending on the selecting signal S14, the write signal S15 to the AND circuit 22 or the write circuit 18. The write circuit 18 receives the selected write signal S15, and outputs the column address of the address decoder 21 to the read circuit 16 on the basis of the write signal S15. The AND circuit 22 receives the selected write signal S15, is activated with the startup signal STH. The AND circuit 22 generates a sampling signal S17 used for moving image data processing on the basis of a column address of the address decoder 21 synchronized with a clock signal and the write signal S15. The AND circuit 22 outputs the sampling signal S17 to the sampling circuit 23.

The CPU & RGB data bus 19 is composed of 24 of data buses for example, and transmits still image data and moving image data outputted from the control circuit 11. Still image data is written into a graphic memory (RAM) via the write circuit 18 that is operated on the basis of the write signal S15. Moving image data is sent to the sampling circuit 23. While moving image data is displayed in the display panel 4, one of the frames of the moving image data is captured in the graphic memory (RAM) 14 as still image data via the write circuit 18 that is operated on the basis of the write signal S15.

The sampling circuit 23 receives the sampling signal S17 and moving image data and latches the moving image data by sampling on the basis of the sampling signal S17 to thereby capture one line (e.g., 240 outputs). Here, the circuit sequentially captures one line, but does not necessarily need to arrange them for one line, and may serially capture them for a necessary column or may capture them at random.

The selector 24 receives an RAM/RGB selecting signal S13, still image data written into the graphic memory (RAM) 14, and moving image data captured in the sampling circuit 23 and the selector 24. The selector 24 selects either the still image data written on the basis of the RAM/RGB selecting signal S13 or the moving image data thus captured. The selector 24 outputs mixed data of a still image and a moving image, still image data or moving image data to the line memory 25.

The line memory 25 receives display data outputted from the latch signal S12 and the selector 24, latches one line on the basis of the latch signal S12 and outputs its data to an output circuit 26.

The output circuit 26 includes an unillustrated level shift circuit, a DAC (Digital to Analog Converter), an outputting circuit, and the like. The output circuit 26 level-shifts digital display data outputted from the line memory 25, and then digital-analogue converts a level-shifted digital display data, on the basis of an output circuit control signal S11 outputted from the control circuit 11. The output circuit 26 outputs the digital-analogue converted display data to the display panel 4.

As shown in FIG. 3, a conventional data line driver 5a is provided with a control circuit 11a, the address decoder 21, the write circuit 18, a read circuit 30, the graphic memory (RAM) 14, the address decoder 15, the read circuit 16, a line memory 33, a shift register 32, the sampling circuit 23, a line memory 31, the selector 24, the output circuit 26, a CPU data bus 36, the read data bus 17, and a RGB data bus 34.

The data line driver 5a receives unillustrated moving image data (RGB data), a clock signal, a horizontal synchronizing signal, and a vertical synchronizing signal, outputted from LCD controller 1 via the RGB I/F (interface). The data line driver 5a also receives unillustrated still image data (CPU data), a write signal, a read signal and other control signals, outputted from CPU 2 through the CPU I/F (interface).

Here, the address decoder 21, the write circuit 18, the read circuit 30, the CPU data bus 36, and the read data bus 17 are included in the CPU port. The read circuit 16 and the line memory 33 are included in the LCD port. The shift register 32, the sampling circuit 23, the line memory 31, and the selector 24 are included in the RGB port.

The control circuit 11a includes an address generator 12a. The address generator 12a outputs address data needed for writing still image data in the graphic memory (RAM) 14 to the address data bus 13.

The address data is inputted in the address decoder 21 as a column address decoder and the address decoder 15 as a row address decoder, via the address data bus 13. The address data outputted from address decoder 21 is outputted to the write circuit 18 and the read circuit 30.

Still image data outputted from the control circuit 11a is inputted in the write circuit 18 through the CPU data bus 36 and is written into the graphic memory (RAM) 14 on the basis of the write signal S15 outputted from the control circuit 11a. The read circuit 30 retrieves the still image data written into the graphic memory (RAM) 14 on the basis of the read signal S16 outputted from the control circuit 11a, and outputs the retrieved image data to the control circuit 11a through the read data bus 17.

The read circuit 16 reads the still image data written into the graphic memory (RAM) 14 on the basis of the read signal 23 outputted from the control circuit 11a, for example for every line. The line memory 33 latches the still image data retrieved on the basis of the latch signal S22 outputted from the control circuit 11a and outputs the latched data to the selector 24, for example for every line.

The shift register 32 generates the sampling signal S24 on the basis of the startup signal STH and the clock signal CLK outputted from the control circuit 11a, and outputs the sampling signal S24 to the sampling circuit 23. Here, a bi-directional shift register is used for the shift register 32. The sampling circuit 23 receives moving image data outputted from the control circuit 11a through the RGB data bus 34 and subjects the received moving image data to latching on the basis of the sampling signal S24. The line memory 31 latches, for example for every line, moving image data subjected to latching on the basis of the latch signal S21 outputted from the control circuit 11a and outputs the signal to the selector 24.

The selector 24 receives still image data outputted from the line memory 33 and moving image data outputted from the line memory 31, selects either one of the still image data and the moving image data on the basis of the RAM/RGB selecting signal S13 outputted from the control circuit 11a, and outputs the selected data as mixed data of the still image data and the moving image data, moving image data, or still image data to the output circuit 26.

The output circuit 26 includes an unillustrated level shift circuit, a DAC, an output circuit, and the like. The output circuit 26 level-shifts digital display data outputted from the selector 24, and then digital-analogue converts a level-shifted digital display data, on the basis of the output circuit control signal S11 outputted from the control circuit 11a. The output circuit 26 outputs the digital-analogue converted display data to the display panel 4.

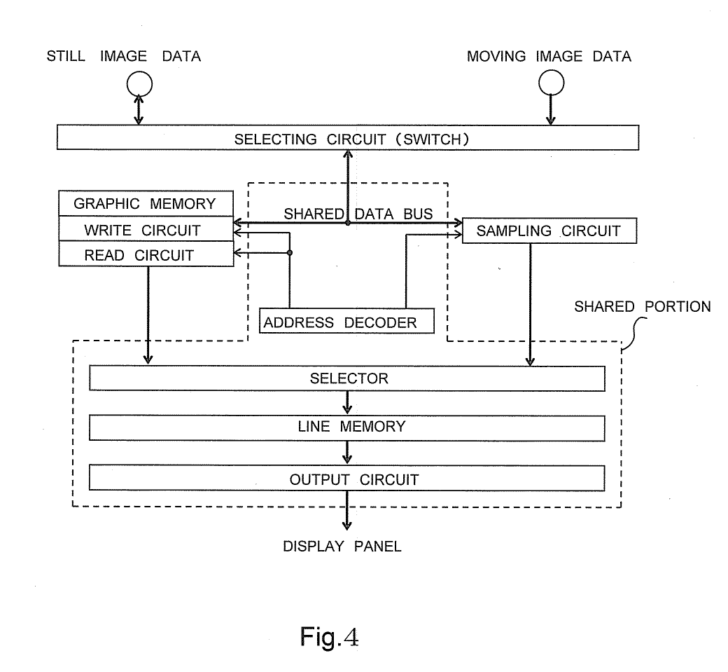

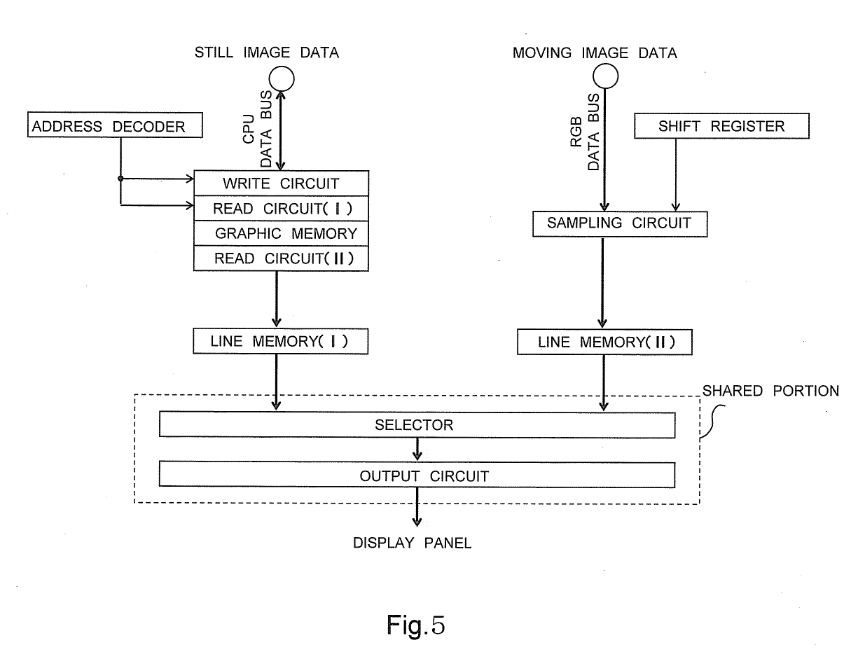

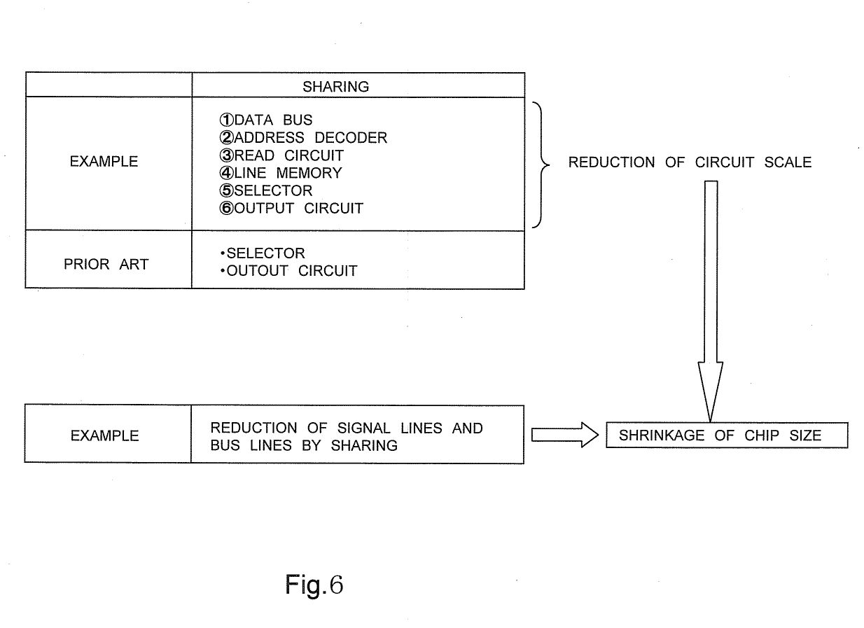

Image data processing in a data line driver will be described referring to FIGS. 4 to 6. FIG. 4 is a schematic diagram indicating a flow of image data processings in a data line driver of this embodiment; FIG. 5 is a schematic diagram indicating a flow of image data processings in a conventional data line driver; FIG. 6 is a diagram indicating an effect of sharing.

As shown in FIG. 4, in the data line driver 5 of this embodiment, the address decoder 21, the selector 24, the line memory 25, the output circuit 26, and the CPU & RGB data bus 19 are shared in the processings for still image data and moving image data. Either still image data or moving image data is selected by the switch 20 (selecting circuit). Column address information is outputted from the address decoder 21 to the write circuit 18 and the read circuit 16 on a still image data side. The sampling signal S17 is inputted into the sampling circuit 23 on the moving image data side, on the basis of the column address information and the write signal S15 of the address decoder 21.

The CPU & RGB data bus 19 sends the still image data to the write circuit 18 and the graphic memory (RAM) 14 on the still image data side and sends moving image data to the sampling circuit 23 on the moving image data side. The still image data outputted from the read circuit 16 on the still image data side and the moving image data outputted from the sampling circuit 23 on the moving image data side are inputted into the selector 24 in a shared portion.

As shown in FIG. 5, the conventional data line driver 5a shares the selector 24 and the output circuit 26 for the processings of the still image data and the moving image data.

On the still image data side, the still image data is outputted to the write circuit 18 and the graphic memory (RAM) 14 via the CPU data bus 36 as a data bus for still image. Column address information is outputted from the address decoder 21 to the write circuit 18 and the read circuit 30. The still image data written into the graphic memory (RAM) 14 is outputted to the line memory 33 through the read circuit 16.

On the moving image data side, the moving image data is outputted to the sampling circuit 23 through the RGB data bus 34 as a data bus for a moving image. The sampling signal S24 is outputted from the shift register 32 to the sampling circuit 23. The moving image data captured from the sampling circuit 23 is outputted to the line memory 31. The still image data outputted from line memory 33 on the still image data side and the moving image data outputted from line memory 31 on the moving image data side is inputted to the selector 24 in a shared portion.

As shown in FIG. 6, in a conventional type of a data line driver, a selector and an output circuit are shared. In a process flow prior to the selector, the still image data and the moving image data is separately processed.

On the other hand, for the present embodiment, a selector, an output circuit, a data bus, an address decoder, a read circuit, and a line memory are shared. The selector 24 and the output circuit 26 are shared as in the conventional case. The data bus (the CPU & RGB data bus 19) shares the conventional type of CPU data bus 36 and the RGB data bus 34. As for the address decoder 21 of the present embodiment, the shift register 32 is substituted by the conventional address decoder 21. The conventional shift register 32 normally has a disadvantage of increasing the circuit size with the use of a bi-directional shift register. In this embodiment, the address generator 12 is used as a counter so there is no need for installing a new counter. Thus the circuit size can be prevented from being increased. As for the read circuit, the conventional read circuits 16 and 30 are shared. As for the line memory 25, the conventional line memories 31 and 33 are shared.

Here, in the conventional data line driver 5a using the shift register 32, the sampling signal S24 can be only generated serially like, for example, 1, 2, 3, . . . , 239, 240, and therefore moving image data can be written only sequentially to the sampling circuit 23. On the other hand, in the data line driver 5 of this embodiment, can designate the address in even numbers. For example, the column address is started with 100, and the column address is ended with 200, so that the column addresses such as 100, 102, 104, . . . , 198, 200 can be outputted. In this way, the present embodiment enables writing to the sampling circuit 23, and improves the flexibility of writing.

In addition, in the data line driver 5 of this embodiment, the switch (selecting circuit) 20 is provided, that is not conventionally provided, and the selecting signal S14 is added. However, this addition hardly increases the size of the chip.

As described above, the display driver of this embodiment is provided with the control circuit 11, the graphic memory (RAM) 14, the address decoder 15, the read circuit 16, the write circuit 18, the switch 20, the address decoder 21, the AND circuit 22, the sampling circuit 23, the selector 24, the line memory 25, the output circuit 26, the address data bus 13, the read data bus 17, and the CPU & RGB data bus 19. The read circuit 16, the read data bus 17, the write circuit 18, the CPU & RGB data bus 19, the switch 20, the address decoder 21, and the AND circuit 22 are included in the CPU port. The CPU & RGB data bus 19, the switch 20, the address decoder 21, the AND circuit 22, the sampling circuit 23, the selector 24, and the line memory 25 are included in the RGB port. The read circuit 16 and the line memory 25 are included in the LCD port. The shared portion of the CPU port and the RGB port includes CPU & RGB data bus 19, the switch 20, the address decoder 21 and the AND circuit 22. The shared portion of the CPU port and the LCD port includes the read circuit 16. The shared portion of the RGB port and the LCD port includes the line memory 25. The address generator 12 receives the startup signal STH and the clock signal CLK and is used as a counter. The address generator 12 is activated by the startup signal STH and generates a column address synchronized with the clock signal CLK and this column address is assigned to the moving image data.

Therefore, the circuit size of the data line driver 5 can be greatly reduced as compared with conventional ones. Moreover, since the circuit and the data bus are shared, the numbers of signal lines and buses can be reduced more than conventional ones. Hence, the chip area of the data line driver 5 can be greatly reduced. In addition, conventionally, a sampling signal can be only serially generated and moving image data can be written only sequentially, while moving image data can be written into the random order and the flexibility of writing can be improved in the present invention. Additionally, since a circuit and a data bus are shared, one screen of the moving image can be cut as a still image by operating the switch 20 (selecting circuit) so as to be cable to supply the write signal S15 to both the RGB port and the CPU port for one screen while displaying the moving image.

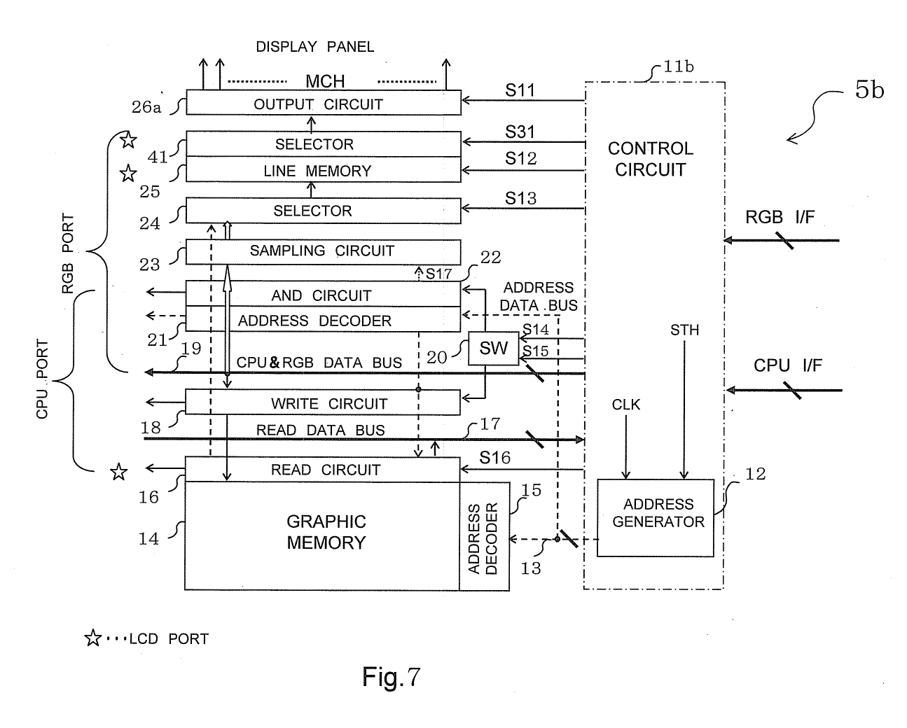

A display driver according to the second embodiment of the present invention will be described with reference to drawings. FIG. 7 is a block diagram indicating a data line driver as a display driver. In this embodiment, display data of one line is time-shared by using a selector and then outputted to an output circuit.

Hereinafter, the same reference numerals are assigned to the same constituents as those of the first embodiment and the description of the same parts will be omitted and only the different parts will be described.

As shown in FIG. 7, the data line driver 5b is provided with a control circuit 11b, the graphic memory (RAM) 14, the address decoder 15, the read circuit 16, the write circuit 18, the switch 20, the address decoder 21, the AND circuit 22, the sampling circuit 23, the selector 24, a selector 41, the line memory 25, an output circuit 26a, the address data bus 13, the read data bus 17, and the CPU & RGB data bus 19.

The data line driver 5b receives unillustrated moving image data (RGB data), a clock signal, a horizontal synchronizing signal, and a vertical synchronizing signal outputted from the LCD controller 1, through the RGB I/F (interface). The data line driver 5b also receives unillustrated still image data (CPU data), a write signal, a read signal, and other control signals outputted from CPU2, through the CPU I/F (interface).

Here, the read circuit 16, the read data bus 17, the write circuit 18, the CPU & RGB data bus 19, the switch 20, the address decoder 21, and the AND circuit 22 are included in a CPU port. The CPU & RGB data bus 19, the switch 20, the address decoder 21, the AND circuit 22, the sampling circuit 23, the selector 24, the line memory 25, and a selector 41 are included in the RGB port. The read circuit 16, the line memory 25, and the selector 41 are included in the LCD port.

The shared portion of the CPU port and the RGB port includes the CPU & RGB data bus 19, the switch 20, the address decoder 21, and the AND circuit 22. The shared portion of the CPU port and the LCD port includes the read circuit 16. The shared portion of the RGB port and the LCD port includes the line memory 25 and the selector 41.

The address generator 12 is provided in the control circuit 11b. The address generator 12 outputs address data needed for writing still image data in the graphic memory (RAM) 14 to the address data bus 13. The address generator 12 receives the startup signal STH and the clock signal CLK and is used as a counter. The address generator 12 is activated with the startup signal STH, and generates a column address synchronized with the clock signal CLK and the generated column address is assigned to moving image data.

The selector 41 is a 3-to-1 selector. The selector 41 receives a color data selecting signal S31 and display data of one line outputted from the line memory 25, and time-shares the display data of one line to three parts per R (red), G (green) and B (blue) on the basis of the color data selecting signal S31 outputted from the control circuit 11b. Then the selector 41 outputs the time-shared display data to the output circuit 26a.

The output circuit 26a includes an unillustrated level shift circuit, DAC, an outputting circuit and the like. The output circuit 26a level-shifts time-shared digital display data outputted from the selector 41, and then digital-analogue converts a level-shifted digital data, on the basis of the output circuit control signal S11. The output circuit 26a outputs the digital-analogue converted display data to the display panel 4. Here, the amount of output from output circuits 26a is for example, 80 which is ⅓ of 240 in the first embodiment.

As described above, the display driver of this embodiment is provided with the control circuit 11b, the graphic memory (RAM) 14, the address decoder 15, the read circuit 16, the write circuit 18, the switch 20, the address decoder 21, the AND circuit 22, the sampling circuit 23, the selector 24, the selector 41, the line memory 25, the output circuit 26, the address data bus 13, the read data bus 17 and the CPU & RGB data bus 19. The read circuit 16, the read data bus 17, the write circuit 18, the CPU & RGB data bus 19, the switch 20, the address decoder 21, and the AND circuit 22 are included in the CPU port. The CPU & RGB data bus 19, the switch 20, the address decoder 21, the AND circuit 22, the sampling circuit 23, the selector 24, the line memory 25, and the selector 41 are included in the RGB port. The read circuit 16, the line memory 25, and the selector 41 are included in the LCD port. The shared portion of the CPU port and the RGB port includes the CPU & RGB data bus 19, the switch 20, the address decoder 21 and the AND circuit 22. The shared portion of the CPU port and the LCD port includes the read circuit 16. The shared portion of the RGB port and the LCD port includes the line memory 25 and the selector 41. The address generator 12 receives the startup signal STH and the clock signal CLK and is used as a counter. The address generator 12 is activated with the startup signal STH and generates a column address synchronized with the clock signal CLK and the generated column address is assigned to moving image data. The selector 41 time-shares the display data of one line to three parts per R (red), G (green) and B (blue) on the basis of the color data selecting signal S31. Then the selector 41 outputs the time-shared display data to the output circuit 26a.

In this way, in addition to an effect similar to that of the first embodiment, the second embodiment can reduce the amount of output as well as the circuit size of the output circuit 26a. Therefore, the chip area of the data line driver 5b can be reduced as compared with the one in the first embodiment.

In addition, in this embodiment, display data of one line is divided into three parts per R, G, and B using the selector 41 and output the divided data to the output circuit 26. However the division is not limited to three and may be arbitrarily divided into n (note that n should be a multiple of 3), for example, 6, 9 or 12. In this case, the division is preferably set as appropriate depending on the capacity of a DAC provided in the output circuit 26. Additionally, the read data bus 17 and the CPU & RGB data bus 19 are separately provided in this embodiment. However, a data bus to be shared for both the read data bus and the CPU & RGB data bus may be provided (data bus shared for CPU & RGB & read).

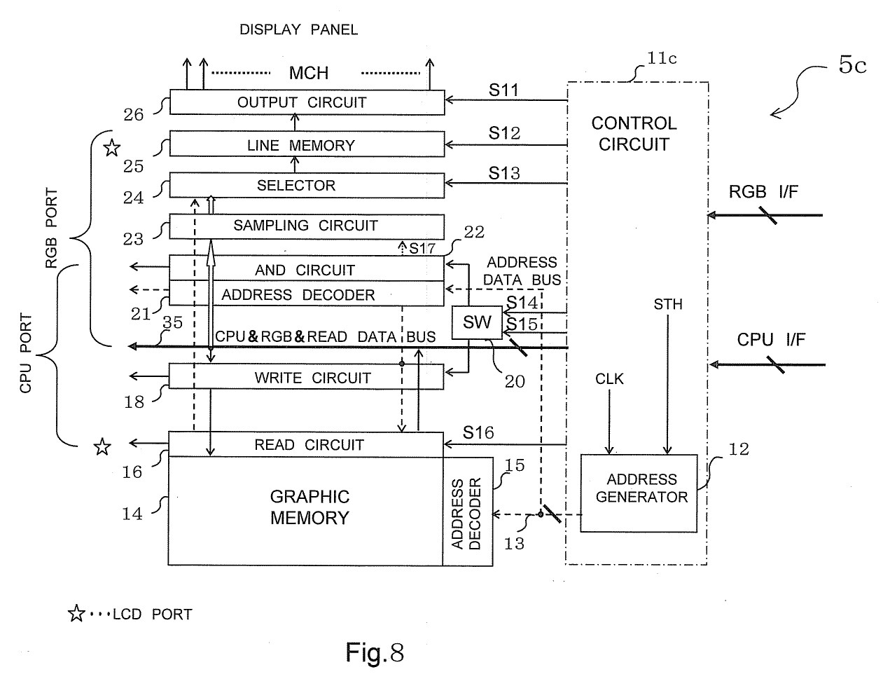

A display driver according to the third embodiment of the present invention will be described referring to drawings. FIG. 8 is a block diagram indicating a data line driver as a display driver. In this embodiment, a read data bus is shared with other buses.

Hereinafter, the same reference numerals are assigned to the same constituents as those of the first embodiment and the description of the same parts is omitted and only the different parts will be described.

As shown in FIG. 8, a data line driver 5c is provided with a control circuit 11c, the graphic memory (RAM) 14, the address decoder 15, the read circuit 16, the write circuit 18, the switch 20, the address decoder 21, the AND circuit 22, the sampling circuit 23, the selector 24, the line memory 25, the output circuit 26, the address data bus 13, and a CPU & RGB & read data bus 35.

The data line driver 5c receives unillustrated moving image data (RGB data), a clock signal, a horizontal synchronizing signal, and a vertical synchronizing signal outputted from the LCD controller 1 through the RGB I/F (interface). The data line driver 5c also receives unillustrated still image data (CPU data), a write signal, a read signal, and other control signals outputted from CPU2 through the CPU I/F (interface).

Here, the read circuit 16, the write circuit 18, a CPU & RGB & read data bus 35, the switch 20, the address decoder 21, and the AND circuit 22 are included in the CPU port. The CPU & RGB & read data bus 35, the switch 20, the address decoder 21, the AND circuit 22, the sampling circuit 23, the selector 24 and the line memory 25 are included in the RGB port. The read circuit 16 and the line memory 25 are included in the LCD port.

The shared portion of the CPU port and the RGB port includes the CPU & RGB & read data bus 35, the switch 20, the address decoder 21, and the AND circuit 22. The shared portion of the CPU port and the LCD port includes the read circuit 16. The shared portion of the RGB port and the LCD port includes the line memory 25.

The address generator 12 is provided in the control circuit 11c. The address generator 12 outputs, to the address data bus 13, address data needed for writing still image data in the graphic memory (RAM) 14. The address generator 12 receives the startup signal STH and the clock signal CLK and is used as a counter. The address generator 12 is activated with the startup signal STH, and generates a column address synchronized with the clock signal CLK and this column address is assigned to moving image data.

The CPU & RGB & read data bus 35 is composed of 24 data buses and transmits still image data and moving image data outputted from the control circuit 11c. In addition, the CPU & RGB & read data bus 35 outputs display data written into the graphic memory (RAM) 14 outputted through the read circuit 16, to the control circuit 11c.

As described above, the display driver of this embodiment is provided with the control circuit 11c, the graphic memory (RAM) 14, the address decoder 15, the read circuit 16, the write circuit 18, the switch 20, the address decoder 21, the AND circuit 22, the sampling circuit 23, the selector 24, the line memory 25, the output circuit 26, the address data bus 13, and the CPU & RGB & read data bus 35. The read circuit 16, the write circuit 18, the CPU & RGB & read data bus 35, the switch 20, the address decoder 21, and the AND circuit 22 are included in the CPU port. The CPU & RGB & read data bus 35, the switch 20, the address decoder 21, the AND circuit 22, the sampling circuit 23, the selector 24 and the line memory 25 are included in the RGB port. The read circuit 16 and the line memory 25 are included the LCD port. The shared portion of the CPU port and the RGB port includes the CPU & RGB & read data bus 35, the switch 20, the address decoder 21, and the AND circuit 22. The shared portion of the CPU port and the LCD port includes the read circuit 16. The shared portion of the RGB port and the LCD port includes the line memory 25. The address generator 12 is activated with the startup signal STH and generates a column address synchronized with the clock signal CLK and the column address thus generated is assigned to moving image data.

With this configuration, the number of data buses can be reduced, in addition to an effect of the first embodiment, since the CPU data bus, the RGB data bus and the read data bus are shared. Therefore the chip area of the data line driver 5c can be reduced as compared with the case in the first embodiment.

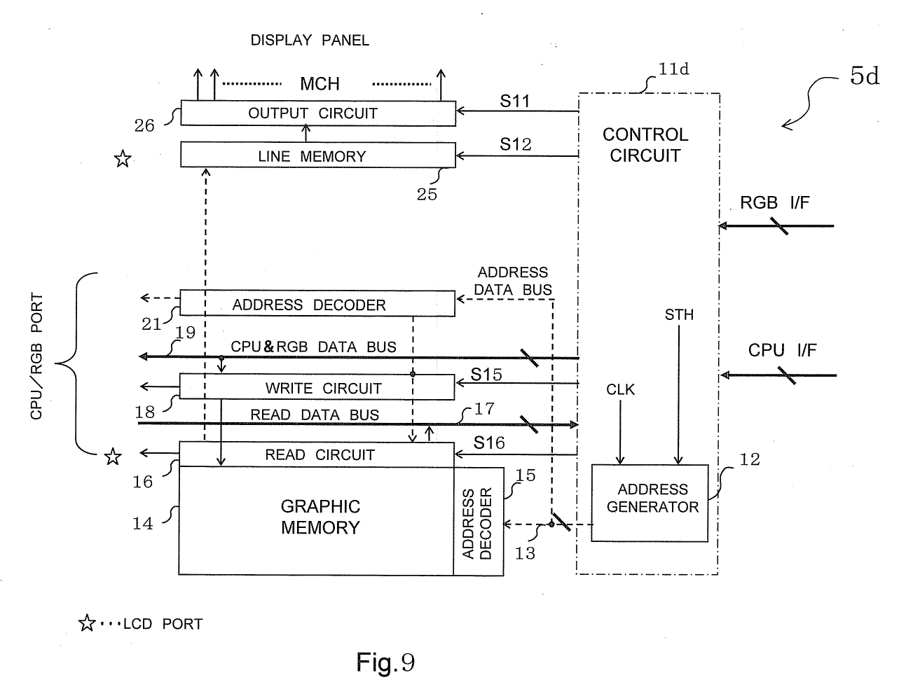

A display driver according to the forth embodiment of the present invention will be described referring to drawings. FIG. 9 is a block diagram indicating a data line driver as a display driver. In this embodiment, still image data and moving image data is memorized in a graphic memory.

Hereinafter, the same reference numerals are assigned to the same constituents as those of the first embodiment and the description of the same parts will be omitted and only the different parts will be described.

As shown in FIG. 9, a data line driver 5d is provided with a control circuit 11d, the graphic memory (RAM) 14, the address decoder 15, the read circuit 16, the write circuit 18, the address decoder 21, the line memory 25, the output circuit 26, the address data bus 13, the read data bus 17 and the CPU & RGB data bus 19.

The data line driver 5d receives unillustrated moving image data (RGB data), a clock signal, a horizontal synchronizing signal, and a vertical synchronizing signal outputted from the LCD controller 1 through the RGB I/F (interface). The data line driver 5d also receives unillustrated still image data (CPU data), a write signal, a read signal and other control signals outputted from the CPU 2 via the CPU I/F (interface).

Here, the read circuit 16, the read data bus 17, the write circuit 18, the CPU & RGB data bus 19 and the address decoder 21 are included in the CPU & RGB port. The read circuit 16 and the line memory port 25 are included in the LCD port. The shared portion of the LCD port and the CPU & RGB port include the read circuit 16.

The address generator 12 is provided in the control circuit 11d. The address generator 12 outputs address data needed for writing still image data in the graphic memory (RAM) 14, to the address data bus 13. The address generator 12 receives the startup signal STH and the clock signal CLK, and is used as a counter. The address generator 12 is activated with the startup signal STH, and generates a column address synchronized with the clock signal CLK and the generated column address is assigned to moving image data.

The CPU & RGB data bus 19 transmits still image data and moving image data outputted from the control circuit 11d. The transmitted still image data and the moving image data is written into the graphic memory (RAM) 14 via the write circuit 18 operated on the basis of the write signal S15 outputted from the control circuit 11d. The still image data and the moving image data written into the graphic memory (RAM) 14 is retrieved by the read circuit 16 on the basis of the read signal S16 outputted from the control circuit 11d and then inputted into the line memory 25.

As described above, the display driver of this embodiment is provided with the control circuit 11d, the graphic memory (RAM) 14, the address decoder 15, the read circuit 16, the write circuit 18, the address decoder 21, the line memory 25, the output circuit 26, the address data bus 13, the read data bus 17 and the CPU & RGB data bus 19. The still image data and the moving image data is written into the graphic memory (RAM) 14 via the CPU & RGB data bus 19. The read circuit 16, the read data bus 17, the write circuit 18, the CPU & RGB data bus 19 and the address decoder 21 are included in the CPU & RGB port. The read circuit 16 and the line memory 25 are included in the LCD port. The shared portion of the CPU port and the CPU & RGB port includes the read circuit 16. The address generator 12 receives the startup signal STH and the clock signal CLK and is used as a counter. The address generator 12 is activated with the startup signal STH and generates a column address synchronized with the clock signal CLK and the generated column address is assigned to moving image data. In other words, even when moving image data is captured, not a sampling circuit but a graphic memory is utilized.

Therefore, the sizes of selectors, sampling circuits, AND circuits, and switches (selecting circuit) can be reduced and thus the circuit size can be reduced more than that of the first embodiment.

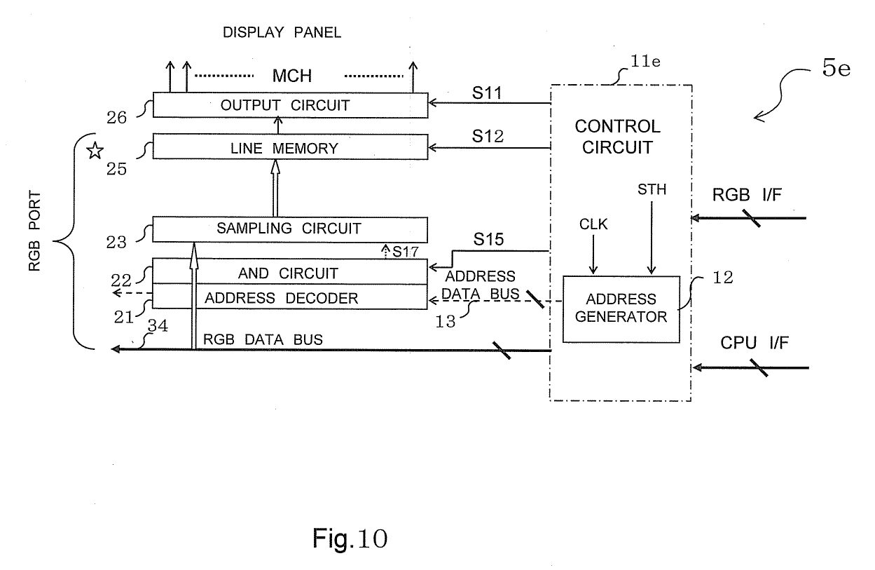

A display driver according to the fifth embodiment of the present invention will be described referring to drawings. FIG. 10 is a block diagram indicating a data line driver as a display driver. In this embodiment, a data line driver only process moving image data.

Hereinafter, the same reference numerals are assigned to the same constituents as those of the first embodiment and the description of the same parts will be omitted and only the different parts will be described.

As shown in FIG. 10, a data line driver 5e is provided with a control circuit 11e, the address decoder 21, the AND circuit 22, the sampling circuit 23, the line memory 25, the output circuit 26, the address data bus 13 and the RGB data bus 34.

The data line driver 5e receives unillustrated moving image data (RGB data), a clock signal, a horizontal synchronizing signal, and a vertical synchronizing signal outputted from the LCD controller 1 through the RGB I/F (interface). The data line driver 5e also receives unillustrated still image data (CPU data), a write signal, a read signal and other control signals outputted from CPU2 via the CPU I/F (interface).

Here, the RGB data bus 34, the address decoder 21, the AND circuit 22, the sampling circuit 23, and the line memory 25 are included in the RGB port. The line memory 25 is included in the LCD port. The shared portion of the RGB port and the LCD port include the line memory 25.

The address generator 12 is provided in the control circuit 11e. The address generator 12 is activated with the startup signal STH, and generates a column address synchronized with the clock signal CLK and the column address thus generated is assigned to moving image data. The address data is inputted into the address decoder 21 as a column address decoder via the address data bus 13.

The sampling circuit 23 receives the sampling signal S17 and moving image data sent from the RGB data bus 34 and latches the moving image data by sampling on the basis of the sampling signal S17 and captures one line (e.g., output of 240).

As described above, the display driver of this embodiment is provided with the control circuit 11e, the address decoder 21, the AND circuit 22, the sampling circuit 23, the line memory 25, the output circuit 26, the address data bus 13 and the RGB data bus 34. The RGB data bus 34, the address decoder 21, the AND circuit 22, the sampling circuit 23 and the line memory 25 are included in the RGB port. The line memory 25 is included in the LCD port. The shared portion of the RGB port and the LCD port include the line memory 25. The address generator 12 receives the startup signal STH and the clock signal CLK and is used as a counter. The address generator 12 is activated by the startup signal STH, generates a column address synchronized with the clock signal CLK, and the column address thus generated is assigned to moving image data.

Therefore, moving image data can be displayed by using a simpler circuit configuration than that of conventional one.

The present invention is not limited to the above embodiments and may be variously modified within the scope of the invention.

For instance, although the present embodiments use a data line driver for a liquid crystal display device, the present embodiments can be also applied to FPDs (Flat Panel Displays) such as OLED (Organic Light Emitting Diode) and PDP (Plasma Display Panel).

What is claimed is:

1. A display driver for sending display data to a display panel, comprising:
a sampling circuit to receive moving image data and a sampling signal generated by a write signal and an address designated with an address decoder, the sampling circuit capturing the moving image data on the basis of the sampling signal; and
a selector to receive still image data, a selecting signal and the moving image data captured by the sampling circuit, the selector selecting one of the still image data and the moving image data on the basis of the selecting signal.

2. The display driver according to claim 1, wherein the still image data is written on a graphic memory, and then the still image data is read from the graphic memory to transmit to the selector, and wherein the address decoder designates a column address of still image data to write on the graphic memory and designates a column address of moving image data to write on the sampling circuit.

3. The display driver according to claim 1, wherein one of the flames of the moving image data is captured and stored in the graphic memory as still image data based on the write signal while displaying the moving image data in the display panel.

4. The display driver according to claim 1, wherein the sampling circuit captures the moving image in order or at random.

5. A display driver for sending display data to a display panel, comprising:
an address generator to receive a startup signal and a clock signal, the address generator starting operation with the startup signal, to generate an address synchronized with the clock signal;
a column address decoder to receive a column address outputted from the address generator;
a raw address decoder to receive a raw address outputted from the address generator;
a write circuit to capture still image data and the column address outputted from the column address decoder on the basis of a write signal;
a graphic memory to write the still image data to an address of the graphic memory designated with the column address decoder and the raw address decoder by operation of the write circuit, based on an address generated with the address generator;
a sampling circuit to receive moving image data and a sampling signal generated by the write signal and a column address designated with the column address decoder, the sampling circuit capturing the moving image data on the basis of the sampling signal;
a selector to receive still image data written on the graphic memory, a selecting signal and the moving image data captured by the sampling circuit, the selector selecting one of the still image data and the moving image data on the basis of the selecting signal; and
a line memory to receive a latch signal and display data outputted from the selector, the line memory latching one of the scanning lines of the display data, on the basis of the latch signal.

6. The display driver according to claim 5, wherein the still image data and the moving image data are transferred through the same data bus.

7. The display driver according to claim 5, wherein the column address decoder designates a column address of still image data to write on the graphic memory and a column address of moving image data to write on the sampling circuit.

8. The display driver according to claim 5, wherein one of the flames of the moving image data is captured and stored in the graphic memory as still image data based on the write signal while displaying the moving image data in the display panel.

9. The display driver according to claim 5, wherein the sampling circuit captures the moving image data in order or at random.

10. The display driver according to claim 5, farther comprising:
an output circuit to level-shift digital display data outputted from the line memory and to digital-analogue convert the level-shifted digital display data, the output circuit outputting the digital-analogue converted display data to the display panel.

11. The display driver according to claim 5, farther comprising:
a read circuit to read still image data written on the graphic memory on the basis of a read signal, the read circuit outputting the still image data as read data.

12. The display driver according to claim 11, wherein the still image data, the moving image data and the read data are transferred through the same data bus.

13. A display driver for sending display data to a display panel, comprising:
an address generator to receive a startup signal and a clock signal, the address generator starting operation with the startup signal, the address generator to generate an address synchronized with the clock signal;
a column address decoder to receive a column address outputted from the address generator;
a raw address decoder to receive a raw address outputted from the address generator;
a write circuit to capture still image data and the column address outputted from the column address decoder on the basis of a write signal;
a graphic memory to write the still image data to an address of the graphic memory designated with the column address decoder and the raw address decoder by operating of the write circuit, based on an address generated with the address generator;
a sampling circuit to receive moving image data and a sampling signal generated by the write signal and a column address designated with the column address decoder, the sampling circuit capturing the moving image data on the basis of the sampling signal;
a first selector to receive still image data written on the graphic memory, a selecting signal and the moving image data captured by the sampling circuit, the first selector selecting one of the still image data and the moving image data on the basis of the selecting signal;
a line memory to receive a latch signal and display data outputted from the selector, the line memory latching one of the scanning lines of the display data, on the basis of the latch signal; and
a second selector to receive a color data selecting signal and the one of the scanning lines of the display data outputted from the line memory, the second selector timesharing the one of the scanning lines of the display data by n times for red data, green data and blue data respectively, on the basis of the color data selecting signal,
wherein n is a positive integer, and a value of n is equal to three or multiples of three.

14. The display driver according to claim 13, wherein the still image data and the moving image data are transferred through the same data bus.

15. The display driver according to claim 13, wherein the column address decoder designates a column address of still image data to write on the graphic memory and designates a column address of moving image data to write on the sampling circuit.

16. The display driver according to claim 13, wherein one of the flames of the moving image data is captured and stored in the graphic memory as still image data based on the write signal while displaying the moving image data in the display panel.

17. The display driver according to claim 13, wherein the sampling circuit captures the moving image data in order or at random.

18. The display driver according to claim 13, farther comprising:
a output circuit to level-shift digital display data outputted from the second selector and to digital-analogue convert the level-shift digital display data, the output circuit displaying the digital-analogue converted data to the display panel.

19. The display driver according to claim 13, farther comprising:
a read circuit to read nonmoving image data written on the graphic memory on the basis of a read signal, the read circuit outputting the still image data as read data.

20. The display driver according to claim 19, wherein the still image data, the moving image data and the read data are transferred through the same data bus.
